(19) United States
(12) Patent Application Publication
(10) Pub. No.: US 2024/0068470 A1
(43) Pub. Date: Feb. 29, 2024

(54) ELECTRIC COMPRESSOR

(71) Applicant: Kabushiki Kaisha Toyota Jidoshokki, Kariya-shi (JP)

(72) Inventors: Ken NAMIKI, Kariya-shi (JP); Takuro Yamashita, Kariya-shi (JP); Takumi Maeda, Kariya-shi (JP); Akinori Tanabe, Kariya-shi (JP); Takafumi Konishi, Kariya-shi (JP); Takahiro Suzuki, Kariya-shi (JP); Yoshitaka Saito, Kariya-shi (JP)

(73) Assignee: KABUSHIKI KAISHA TOYOTA JIDOSHOKKI, Kariya-shi (JP)

(21) Appl. No.: 18/225,791

(22) Filed: Jul. 25, 2023

(30) Foreign Application Priority Data
Aug. 30, 2022 (JP) 2022-137251

(51) Int. Cl. F04C 2/02

(52) U.S. Cl. CPC F04C 2/025; F04C 2240/30; F04C 2240/40

(57) ABSTRACT

An electric compressor includes: a compression part; an electric motor; an inverter; a housing including a plurality of housing forming members made of metal; a seal member that has an insulation property and is provided between the housing forming members adjacent to each other; and a potential equalization member that is made of metal and is in contact with both the adjacent housing forming members to equalize potentials of the adjacent housing forming members. The adjacent housing forming members include mating surfaces, respectively. An insertion hole is formed in one of the mating surfaces of the adjacent housing forming members, at a position in which the seal member is not provided. The potential equalization member includes an insertion portion inserted into the insertion hole, and a contact portion that is a plate portion extending in a gap between the mating surfaces and is in contact with both the mating surfaces.

### CROSS-REFERENCE TO RELATED APPLICATION

This application claims priority to Japanese Patent Application No. 2022-137251 filed on Aug. 30, 2022, the entire disclosure of which is incorporated herein by reference.

### BACKGROUND ART

The present disclosure relates to an electric compressor.

The electric compressor includes a compression part, an electric motor, an inverter, a housing, and a seal member. The compression part compresses fluid. The electric motor drives the compression part. The inverter drives the electric motor. The housing accommodates the compression part, the electric motor, and the inverter. The housing includes a plurality of housing forming members made of metal. The seal member is provided between the housing forming members adjacent to each other. The seal member has an insulation property. The adjacent housing forming members have mating surfaces facing each other, respectively, the mating surfaces sandwiching the seal member.

The adjacent housing forming members are insulated by the seal member. For example, an electric compressor disclosed in Japanese Patent Application Publication No. 2020-070741 includes a potential equalization member made of metal. The potential equalization member is in contact with the adjacent housing forming members insulated by the seal member to equalize potentials of the adjacent housing forming members. In the electric compressor disclosed in Japanese Patent Application Publication No. 2020-070741, insertion holes facing each other are formed in the mating surfaces of the adjacent housing forming members, respectively, at positions in which the seal member is not provided. The potential equalization member is inserted into the facing insertion holes. The potential equalization member is in contact with an inner circumferential surface of each of the insertion holes.

At a time of assembling the adjacent housing forming members with each other, one end of the potential equalization member may be inserted into one of the facing insertion holes, and then, the other end of the potential equalization member may be inserted into the other of the facing insertion holes, for example. Alternatively, at a time of assembling the adjacent housing forming members with each other, the potential equalization member may be inserted into the facing insertion holes at the same time, for example.

The adjacent housing forming members need to be assembled while checking whether the potential equalization member is inserted into the insertion holes. Therefore, it may take time and effort to assemble the adjacent housing forming members while equalizing potentials of the adjacent housing forming members.

### SUMMARY

In accordance with an aspect of the present disclosure, there is provided an electric compressor including: a compression part that compresses fluid; an electric motor that drives the compression part; an inverter that drives the electric motor; a housing that accommodates the compression part, the electric motor, and the inverter, and includes a plurality of housing forming members made of metal; a seal member that has an insulation property and is provided between the housing forming members adjacent to each other; and a potential equalization member that is made of metal and is in contact with both the adjacent housing forming members to equalize potentials of the adjacent housing forming members. The adjacent housing forming members include mating surfaces facing each other, respectively. The mating surfaces sandwiches the seal member. An insertion hole is formed in one of the mating surfaces of the adjacent housing forming members, at a position in which the seal member is not provided. The potential equalization member includes an insertion portion inserted into the insertion hole, and a contact portion that is a plate portion extending in a gap between the mating surfaces and is in contact with both the mating surfaces.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view of an electric compressor;

FIG. 2 is a drawing of a part of the electric compressor as viewed from an arrow A of FIG. 1;

FIG. 3 is a perspective view of a potential equalization member according to a first embodiment;

FIG. 4 is a cross-sectional view of an arrangement of a first potential equalization member;

FIG. 5 is a cross-sectional view of an arrangement of a second potential equalization member;

FIG. 6 is a perspective view of a potential equalization member according to a second embodiment;

FIG. 7 is a cross-sectional view of an arrangement of a first potential equalization member according to the second embodiment; and

FIG. 8 is a cross-sectional view of an arrangement of a second potential equalization member according to the second embodiment.

### DETAILED DESCRIPTION OF THE EMBODIMENTS

### First Embodiment

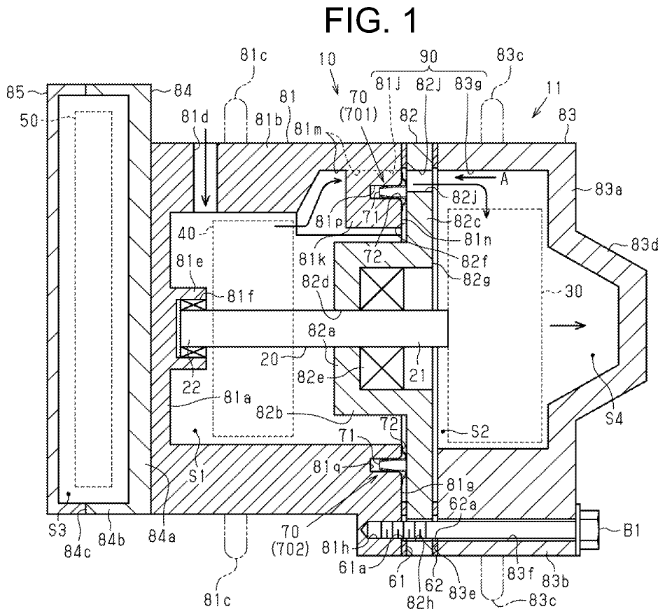

Hereinafter, a first embodiment in which a scroll electric compressor embodies an electric compressor will be described with reference to FIG. 1 to FIG. 5. The electric compressor of the present embodiment is mounted on a vehicle, and is used for a vehicle air conditioner.

Electric Compressor As illustrated in FIG. 1, an electric compressor 10 includes a housing 11 having a tubular shape, a rotary shaft 20, a compression part 30, an electric motor 40, an inverter 50, a first seal member 61, and a second seal member 62. The housing 11 accommodates the rotary shaft 20, the compression part 30, the electric motor 40, and the inverter 50.

The housing 11 includes a first housing forming member 81, a second housing forming member 82, a third housing forming member 83, a fourth housing forming member 84, and a fifth housing forming member 85. The first housing forming member 81, the second housing forming member 82, the third housing forming member 83, the fourth housing forming member 84, and the fifth housing forming member 85 are made of aluminum, for example. The first housing forming member 81, the second housing forming member 82, the third housing forming member 83, the fourth housing forming member 84, and the fifth housing forming member 85 are housing forming members forming the housing 11. Thus, the housing 11 is formed of a plurality of housing forming members made of metal.

The first housing forming member 81, the second housing forming member 82, and the third housing forming member 83 form a motor accommodation chamber S1 and a compression part accommodation chamber S2. The motor accommodation chamber S1 accommodates the electric motor 40. The compression part accommodation chamber S2 accommodates the compression part 30. A suction passage 90 into which refrigerant as fluid is drawn into the compression part 30 is formed in the first housing forming member 81, the second housing forming member 82, and the third housing forming member 83. The fourth housing forming member 84 and the fifth housing forming member 85 form an inverter accommodation chamber S3. The inverter accommodation chamber S3 accommodates the inverter 50.

The compression part 30 compresses refrigerant. The compression part 30 is a scroll type compression part including a fixed scroll and a movable scroll (not illustrated), for example. A first end portion 21 of the rotary shaft 20 is connected to the compression part 30. The electric motor 40 rotates the rotary shaft 20. The refrigerant is compressed in the compression part 30 in response to the rotation of the rotary shaft 20. The electric motor 40 drives the compression part 30. The inverter 50 drives the electric motor 40.

Each Housing Forming Member, First Seal Member, Second Seal Member

The first housing forming member 81 includes an end wall 81a having a plate shape, a peripheral wall 81b having a tubular shape, and a plurality of mounting legs 81c. The peripheral wall 81b extends from an outer periphery of the end wall 81a. An axial direction of the peripheral wall 81b coincides with an axial direction of the rotary shaft 20. Bolts are inserted in the mounting legs 81c, respectively, when the electric compressor 10 is mounted on a vehicle body.

The first housing forming member 81 has a suction port 81d. The refrigerant is drawn from the suction port 81d. The suction port 81d is formed in a part of the peripheral wall 81b close to the end wall 81a. An inside and an outside of the first housing forming member 81 communicate with each other through the suction port 81d.

The first housing forming member 81 includes a boss portion 81e having a cylindrical shape. The boss portion 81e protrudes from a central portion of an inner surface of the end wall 81a. A second end portion 22 of the rotary shaft 20 is inserted into the boss portion 81e. The electric compressor 10 includes a bearing 81f. The bearing 81f is, for example, a rolling bearing. The bearing 81f is disposed between an inner circumferential surface of the boss portion 81e and an outer circumferential surface of the second end portion 22 of the rotary shaft 20. The second end portion 22 of the rotary shaft 20 is rotatably supported in the first housing forming member 81 via the bearing 81f.

The first housing forming member 81 includes an open end surface 81g. The open end surface 81g is an end surface of the peripheral wall 81b opposite to the end wall 81a. The open end surface 81g extends in a direction perpendicular to an axis of the peripheral wall 81b of the first housing forming member 81.

The first housing forming member 81 includes a plurality of internal thread grooves 81h. The internal thread grooves 81h are formed in the open end surface 81g. FIG. 1 illustrates one of the internal thread grooves 81h for convenience of explanation.

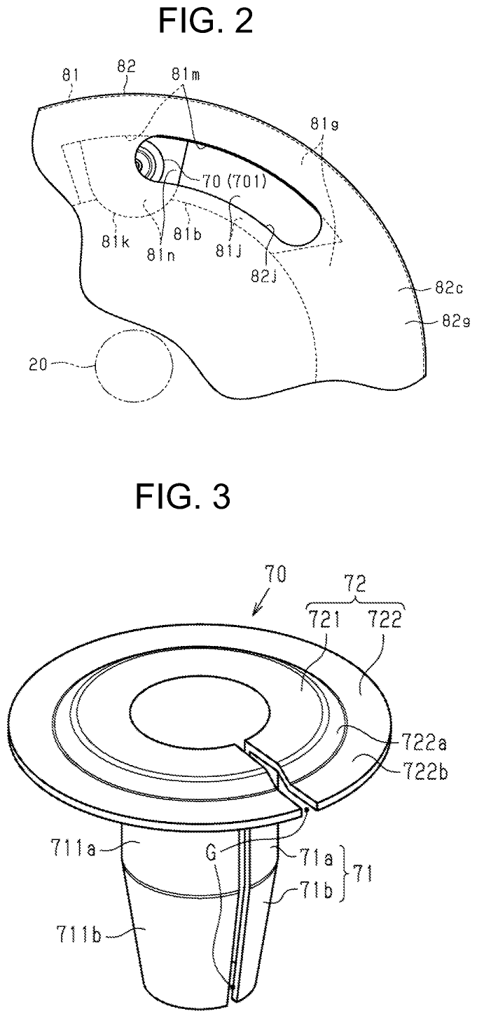

As illustrated in FIG. 1 and FIG. 2, the first housing forming member 81 includes a groove 81j. The groove 81j forms a part of the suction passage 90. The groove 81j is formed in an inner circumferential surface of the peripheral wall 81b of the first housing forming member 81. The groove 81j is opened at the open end surface 81g. The groove 81j has an arc surface 81m. The arc surface 81m is one of surfaces defining the groove 81j, which is farthest from the rotary shaft 20. A plurality of grooves 81j are provided in the first housing forming member 81 (not illustrated). FIG. 1 and FIG. 2 each illustrate one of the grooves 81j for convenience of explanation.

As illustrated in FIG. 2, the groove 81j has an arc shape and extends in a peripheral direction of the peripheral wall 81b of the first housing forming member 81. The first housing forming member 81 includes an extended wall portion 81k. The extended wall portion 81k extends from the arc surface 81m of the groove 81j toward an inside of the peripheral wall 81b. The extended wall portion 81k is provided at a part of the arc surface 81m.

As illustrated in FIG. 1, the extended wall portion 81k has an axial end surface 81n. The axial end surface 81n is an end surface of the extended wall portion 81k opposite to the end wall 81a. The axial end surface 81n is flush with the open end surface 81g.

The first housing forming member 81 includes a first insertion hole 81p and a second insertion hole 81q. Each of the first insertion hole 81p and the second insertion hole 81q is a round hole. The first insertion hole 81p is formed in the axial end surface 81n of the extended wall portion 81k. The first insertion hole 81p does not extend through the extended wall portion 81k in a thickness direction of the extended wall portion 81k. The second insertion hole 81q is formed in the open end surface 81g. The second insertion hole 81q is formed adjacently to the internal thread groove 81h illustrated in FIG. 1 in a radial direction of the rotary shaft 20. The second insertion hole 81q is provided closer to the rotary shaft 20 than the internal thread groove 81h is, as illustrated in FIG. 1. The first insertion hole 81p and the second insertion hole 81q are provided at positions symmetrical to each other in the radial direction of the rotary shaft 20.

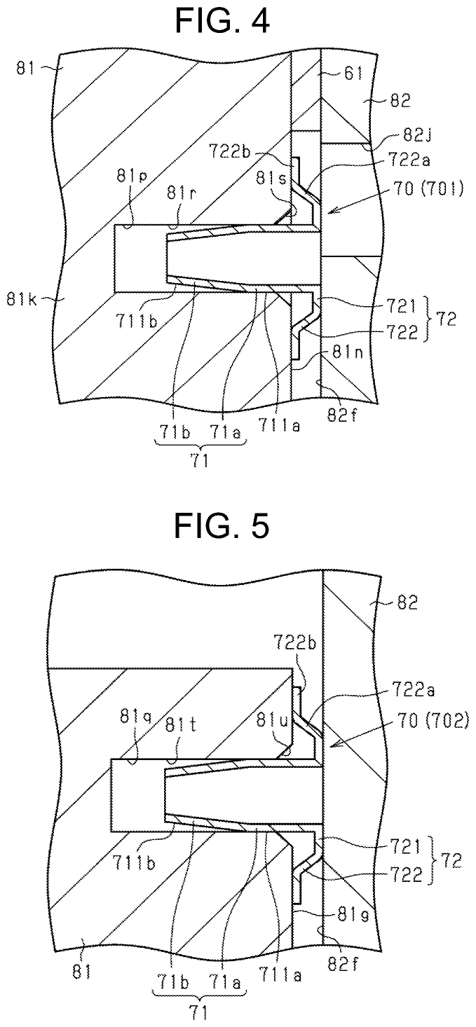

As illustrated in FIG. 4, the first insertion hole 81p includes an inner circumferential surface 81r and a tapered surface 81s. The inner circumferential surface 81r is a cylindrical surface. The tapered surface 81s corresponds to a chamfered part of the first insertion hole 81p when the first insertion hole 81p is formed. The tapered surface 81s is positioned at an inlet of the first insertion hole 81p.

As illustrated in FIG. 5, the second insertion hole 81q includes an inner circumferential surface 81t and a tapered surface 81u. The inner circumferential surface 81t is a cylindrical surface. The tapered surface 81u corresponds to a chamfered part of the second insertion hole 81q when the second insertion hole 81q is formed. The tapered surface 81u is positioned at an inlet of the second insertion hole 81q.

As illustrated in FIG. 1, the second housing forming member 82 includes an end wall 82a having a plate shape, a peripheral wall 82b having a tubular shape, and a flange wall 82c having an annular shape. The peripheral wall 82b extends from an outer periphery of the end wall 82a. An axial direction of the peripheral wall 82b coincides with the axial direction of the rotary shaft 20. The flange wall 82c extends from an outer circumferential surface of an end portion of the peripheral wall 82b opposite to the end wall 82a toward a radially outward side of the rotary shaft 20.

The second housing forming member 82 has an insertion hole 82d that is a round hole. The insertion hole 82d is formed in a central portion of the end wall 82a. The insertion hole 82d extends through the end wall 82a in a thickness direction of the end wall 82a. The rotary shaft 20 is inserted into the insertion hole 82d. The first end portion 21 of the rotary shaft 20 is positioned inside the peripheral wall 82b. The electric compressor 10 includes a bearing 82e. The bearing 82e is a rolling bearing, for example. The bearing 82e is provided between an inner circumferential surface of the peripheral wall 82b and an outer circumferential surface of the first end portion 21 of the rotary shaft 20. The first end portion 21 of the rotary shaft 20 is rotatably supported in the second housing forming member 82 via the bearing 82e. The rotary shaft 20 is rotatably supported in the housing 11.

The flange wall 82c has a first surface 82f and a second surface 82g. The first surface 82f and the second surface 82g are each a flat surface positioned in a thickness direction of the flange wall 82c. The first surface 82f is a surface of the flange wall 82c close to the end wall 82a. The second surface 82g is a surface of the flange wall 82c opposite to the end wall 82a.

The second housing forming member 82 includes a plurality of bolt insertion holes 82h. Each of the bolt insertion holes 82h is formed in the flange wall 82c. Each of the bolt insertion holes 82h extends through the flange wall 82c in the thickness direction of the flange wall 82c. FIG. 1 illustrates one of the bolt insertion holes 82h for convenience of explanation.

The second housing forming member 82 includes a plurality of communication holes 82j. Each of the communication holes 82j forms a part of the suction passage 90. Each of the communication holes 82j extends through the flange wall 82c in the thickness direction of the flange wall 82c. FIG. 1 illustrates one of the communication holes 82j for convenience of explanation. The one of the communication holes 82j and the one of the bolt insertion holes 82h illustrated in FIG. 1 are provided at positions symmetrical to each other in the radial direction of the rotary shaft 20. As illustrated in FIG. 2, each of the communication holes 82j has an arc shape and extends in a peripheral direction of the flange wall 82c of the second housing forming member 82.

As illustrated in FIG. 1, the peripheral wall 81b and the extended wall portion 81k of the first housing forming member 81 are joined to the flange wall 82c of the second housing forming member 82 via the first seal member 61. The first housing forming member 81 and the second housing forming member 82 are housing forming members adjacent to each other. The internal thread grooves 81h of the first housing forming member 81 face the bolt insertion holes 82h of the second housing forming member 82, respectively. The grooves 81j of the first housing forming member 81 face the communication holes 82j of the second housing forming member 82, respectively.

As illustrated in FIG. 2, in a state where the groove 81j faces the communication hole 82j, a part of the extended wall portion 81k faces a part of the communication hole 82j. In the extended wall portion 81k, at least one of the communication holes 82j communicates with one of the grooves 81j facing such a communication hole 82j.

As illustrated in FIG. 1, the first seal member 61 is a gasket. The first seal member 61 is a seal member having an insulation property. The first seal member 61 is provided between the first housing forming member 81 and the second housing forming member 82. The first seal member 61 is provided between the open end surface 81g and the axial end surface 81n of the first housing forming member 81, and the first surface 82f of the second housing forming member 82. The open end surface 81g and the axial end surface 81n, and the first surface 82f correspond to mating surfaces sandwiching the first seal member 61. That is, the first housing forming member 81 and the second housing forming member 82 have the mating surfaces, respectively, sandwiching the first seal member 61.

The first seal member 61 is provided along the entire periphery of the open end surface 81g of the first housing forming member 81, at the outermost position in the radial direction of the rotary shaft 20. The first seal member 61 is provided on the radially outward side of the rotary shaft 20 relative to the grooves 81j of the first housing forming member 81. The first seal member 61 does not cover the grooves 81j. The first seal member 61 does not cover the axial end surface 81n. The axial end surface 81n corresponds to a part of the mating surface of the first housing forming member 81, at a position in which the first seal member 61 is not provided. The first seal member 61 does not cover the first insertion hole 81p. The first seal member 61 does not cover the second insertion hole 81q. The first insertion hole 81p and the second insertion hole 81q are insertion holes formed in a part of the mating surface of the first housing forming member 81, at positions in which the first seal member 61 is not provided. The first seal member 61 has a plurality of bolt insertion holes 61a. The bolt insertion holes 61a communicate with the internal thread grooves 81h, respectively. FIG. 1 illustrates one of the bolt insertion holes 61a for convenience of explanation.

The first seal member 61 is provided along the entire periphery of the first surface 82f of the second housing forming member 82, at the outermost position in the radial direction of the rotary shaft 20. The first seal member 61 is provided on the radially outward side of the rotary shaft 20 relative to the communication holes 82j of the second housing forming member 82. The first seal member 61 does not cover the communication holes 82j. The bolt insertion holes 61a of the first seal member 61 communicate with the bolt insertion holes 82h, respectively. The first seal member 61 does not cover the bolt insertion holes 82h.

The first housing forming member 81 is joined to the second housing forming member 82 via the first seal member 61 to form the motor accommodation chamber S1. The motor accommodation chamber S1 is defined by the first housing forming member 81 and the second housing forming member 82. The motor accommodation chamber S1 communicates with the suction port 81d. The refrigerant from the suction port 81d is drawn into the motor accommodation chamber S1.

The third housing forming member 83 includes an end wall 83a having a plate shape, a peripheral wall 83b having a tubular shape, and a plurality of mounting legs 83c. The peripheral wall 83b extends from an outer periphery of the end wall 83a. An axial direction of the peripheral wall 83b coincides with the axial direction of the rotary shaft 20. The peripheral wall 83b surrounds the compression part 30. Bolts are inserted in the mounting legs 83c, respectively, when the electric compressor 10 is mounted on the vehicle body.

The third housing forming member 83 includes a discharge chamber forming recess 83d. The discharge chamber forming recess 83d is recessed from a part of the end wall 83a such that the part of the end wall 83a is spaced from the compression part 30 in the axial direction of the rotary shaft 20. A discharge chamber S4 is defined by the discharge chamber forming recess 83d and the compression part 30. The discharge chamber S4 is also defined by the discharge chamber forming recess 83d and the fixed scroll (not illustrated).

The third housing forming member 83 has an open end surface 83e. The open end surface 83e is an end surface of the peripheral wall 83b opposite to the end wall 83a. The open end surface 83e extends in a direction perpendicular to an axis of the peripheral wall 83b of the third housing forming member 83.

The third housing forming member 83 has a plurality of bolt insertion holes 83f. The bolt insertion holes 83f are formed in the open end surface 83e. FIG. 1 illustrates one of the bolt insertion holes 83f for convenience of explanation.

The third housing forming member 83 has a plurality of grooves 83g. Each of the grooves 83g forms a part of the suction passage 90. Each of the grooves 83g is formed in an inner circumferential surface of the peripheral wall 83b of the third housing forming member 83. Each of the grooves 83g is opened in the open end surface 83e. FIG. 1 illustrates one of the grooves 83g for convenience of explanation.

The flange wall 82c of the second housing forming member 82 is joined to the peripheral wall 83b of the third housing forming member 83 via the second seal member 62. The bolt insertion holes 82h of the second housing forming member 82 face the bolt insertion holes 83f of the third housing forming member 83, respectively. The communication holes 82j of the second housing forming member 82 face the grooves 83g of the third housing forming member 83, respectively.

The second seal member 62 is a gasket. The second seal member 62 has an insulation property. The second seal member 62 is provided between the second housing forming member 82 and the third housing forming member 83. The second seal member 62 is provided between the second surface 82g of the second housing forming member 82 and the open end surface 83e of the third housing forming member 83.

The second seal member 62 is provided along the entire periphery of the second surface 82g of the second housing forming member 82, at the outermost position in the radial direction of the rotary shaft 20. The second seal member 62 is provided on the radially outward side of the rotary shaft 20 relative to the communication holes 82j of the second housing forming member 82. The second seal member 62 does not cover the communication holes 82j. The second seal member 62 has a plurality of bolt insertion holes 62a. The bolt insertion holes 62a communicate with the bolt insertion holes 82h, respectively. FIG. 1 illustrates one of the bolt insertion holes 62a for convenience of explanation.

The second seal member 62 is provided along the entire periphery of the open end surface 83e of the third housing forming member 83, at the outermost position in the radial direction of the rotary shaft 20. The second seal member 62 is provided on the radially outward side of the rotary shaft 20 relative to the grooves 83g of the third housing forming member 83. The second seal member 62 does not cover the grooves 83g. The bolt insertion holes 62a of the second seal member 62 communicate with the bolt insertion holes 83f, respectively. The second seal member 62 does not cover the bolt insertion holes 83f.

The second housing forming member 82 is joined to the third housing forming member 83 via the second seal member 62 to form the compression part accommodation chamber S2. The compression part accommodation chamber S2 is defined by the second housing forming member 82 and the third housing forming member 83. The first housing forming member 81, the second housing forming member 82, and the third housing forming member 83 are joined to each other in the axial direction of the rotary shaft 20, so that the suction passage 90 is formed by the grooves 81j, the communication holes 82j, and the grooves 83g.

In a state where the first housing forming member 81, the second housing forming member 82, and the third housing forming member 83 are joined to each other in the axial direction of the rotary shaft 20, a bolt B1 is inserted into each of the bolt insertion holes 83f, 62a, 82h, and 61a. An inner diameter of each of the bolt insertion holes 83f, 62a, 82h, and 61a is greater than a diameter of the bolt B1. A distal end of the bolt B1 is screwed into each of the internal thread grooves 81h of the first housing forming member 81. The bolt B1 is in contact with the first housing forming member 81 and the third housing forming member 83, and not in contact with the second housing forming member 82. The first seal member 61 and the second seal member 62 are compressed by a fastening force of the bolt B1. The first seal member 61 seals a gap between the first housing forming member 81 and the second housing forming member 82. The second seal member 62 seals a gap between the second housing forming member 82 and the third housing forming member 83. The refrigerant drawn into the motor accommodation chamber S1 is introduced into the compression part accommodation chamber S2 through the suction passage 90. At this time, the first seal member 61 and the second seal member 62 prevent the refrigerant passing through the suction passage 90 from leaking to an outside of the housing 11. The compression part 30 compresses the refrigerant introduced into the compression part accommodation chamber S2, and then, discharges the compressed refrigerant toward the discharge chamber S4.

The fourth housing forming member 84 includes an end wall 84a having a plate shape, a peripheral wall 84b having a tubular shape, and an open end surface 84c. The peripheral wall 84b extends from an outer periphery of the end wall 84a. The open end surface 84c is an end surface of the peripheral wall 84b opposite to the end wall 84a. The open end surface 84c extends in a direction perpendicular to an axis of the peripheral wall 84b of the fourth housing forming member 84. The end wall 84a of the fourth housing forming member 84 is joined to the end wall 81a of the first housing forming member 81 in the axial direction of the rotary shaft 20. A gasket (not illustrated) having an insulation property is disposed between the first housing forming member 81 and the fourth housing forming member 84.

The fifth housing forming member 85 is joined to the open end surface 84c of the peripheral wall 84b of the fourth housing forming member 84. The housing 11 of the present embodiment is formed by all the housing forming members arranged in the axial direction of the rotary shaft 20. The fourth housing forming member 84 is joined to the fifth housing forming member 85 to form the inverter accommodation chamber S3. The inverter accommodation chamber S3 is defined by the fourth housing forming member 84 and the fifth housing forming member 85. A gasket (not illustrated) having an insulation property is disposed between the fourth housing forming member 84 and the fifth housing forming member 85. The fourth housing forming member 84 and the fifth housing forming member 85 are fixed with a bolt (not illustrated). The fifth housing forming member 85 and the first housing forming member 81 are fixed with a bolt (not illustrated). The bolt is not in contact with the fourth housing forming member 84.

Potential Equalization Member

The electric compressor 10 includes two potential equalization members 70. Each of the potential equalization members 70 is made of metal and is in contact with both the first housing forming member 81 and the second housing forming member 82 to equalize potentials of the first housing forming member 81 and the second housing forming member 82. The potential equalization members 70 are made of brass, for example. The potential equalization members 70 may be made of copper, for example.

As illustrated in FIG. 3, each of the potential equalization members 70 is formed of a single thin plate. Each of the potential equalization members 70 includes an insertion portion 71 having a tubular shape and a contact portion 72 having a circular plate shape. The insertion portion 71 is formed by the single thin plate being curved into a cylindrical shape. The contact portion 72 extends from a first end of the insertion portion 71 in an axial direction of the insertion portion 71 toward a radially outward side of the insertion portion 71. Each of the potential equalization members 70 has a gap G. The gap G extends from a second end of the insertion portion 71 in the axial direction of the insertion portion 71 to an outer edge of the contact portion 72. As a dimension of the gap G is reduced in a peripheral direction of the insertion portion 71, an outer diameter of the insertion portion 71 is reduced in a radial direction of the insertion portion 71. The insertion portion 71 has a spring structure that is elastically deformable in the radial direction of the insertion portion 71.

As illustrated in FIG. 4 and FIG. 5, the insertion portion 71 of one of the potential equalization members 70 is inserted into the first insertion hole 81p, the insertion portion 71 of the other of the potential equalization members 70 is inserted into the second insertion hole 81q. The insertion portion 71 includes a first tubular portion 71a and a second tubular portion 71b. The first tubular portion 71a is continuous with the contact portion 72. The first tubular portion 71a has an outer circumferential surface 711a. That is, the insertion portion 71 has the outer circumferential surface 711a. The outer circumferential surface 711a of the insertion portion 71 is a cylindrical surface having a constant outer diameter in the axial direction of the insertion portion 71. The outer diameter of the outer circumferential surface 711a of the insertion portion 71 is greater than an inner diameter of the inner circumferential surface 81r of the first insertion hole 81p and an inner diameter of the inner circumferential surface 81t of the second insertion hole 81q before the insertion portion 71 is inserted into the first insertion hole 81p or the second insertion hole 81q. When the insertion portion 71 is inserted into the first insertion hole 81p and the second insertion hole 81q, the dimension of the gap G of the potential equalization member 70 illustrated in FIG. 3 is reduced in the peripheral direction of the insertion portion 71. Thus, the outer circumferential surface 711a of the insertion portion 71 is in contact with and pressed against the inner circumferential surface 81r of the first insertion hole 81p and the inner circumferential surface 81t of the second insertion hole 81q.

The second tubular portion 71b is provided adjacently to the first tubular portion 71a at a position opposite to the contact portion 72. The second tubular portion 71b is formed integrally with the first tubular portion 71a. The second tubular portion 71b has a conical surface 711b. The conical surface 711b is an outer surface of the second tubular portion 71b. The conical surface 711b is continuous with the outer circumferential surface 711a of the first tubular portion 71a. The conical surface 711b is an inclined surface whose outer diameter is gradually reduced as being away from the contact portion 72 in the axial direction of the insertion portion 71. An outer diameter of the second tubular portion 71b is gradually reduced as being away from the contact portion 72 in the axial direction of the insertion portion 71.

One of the potential equalization members 70, which includes the insertion portion 71 to be inserted into the first insertion hole 81p, is referred to as a first potential equalization member 701. The other of the potential equalization members 70, which includes the insertion portion 71 to be inserted into the second insertion hole 81q, is referred to as a second potential equalization member 702.

As illustrated in FIG. 4, a part of the contact portion 72 of the first potential equalization member 701 faces the communication hole 82j of the second housing forming member 82. A part of the contact portion 72 of the first potential equalization member 701 not facing the communication hole 82j of the second housing forming member 82 extends in a gap between the first surface 82f of the second housing forming member 82 and the axial end surface 81n of the first housing forming member 81. A part of the contact portion 72 of the first potential equalization member 701 not facing the communication hole 82j of the second housing forming member 82 is in contact with both the first surface 82f and the axial end surface 81n.

As illustrated in FIG. 5, the contact portion 72 of the second potential equalization member 702 extends in a gap between the first surface 82f of the second housing forming member 82 and the open end surface 81g of the first housing forming member 81. The contact portion 72 of the second potential equalization member 702 is in contact with both the first surface 82f and the open end surface 81g.

As illustrated in FIG. 4 and FIG. 5, the contact portion 72 of each of the potential equalization members 70 extends in a gap between the mating surfaces facing each other of the adjacent housing forming members, and is in contact with such mating surfaces.

As illustrated in FIG. 3, the contact portion 72 of each of the potential equalization members 70 includes a first plate portion 721 and a second plate portion 722. The first plate portion 721 is continuous with the insertion portion 71. The first plate portion 721 has a circular flat plate shape. The first plate portion 721 extends from the first end of the insertion portion 71 in the axial direction of the insertion portion 71 toward a radially outward side of the insertion portion 71. The second plate portion 722 is continuous with an outer edge of the first plate portion 721.

The second plate portion 722 includes a conical plate portion 722a and a circular plate portion 722b. The conical plate portion 722a is continuous with the first plate portion 721. The conical plate portion 722a extends outward in the radial direction of the insertion portion 71, from the outer edge of the first plate portion 721 toward the second end of the insertion portion 71 in the axial direction of the insertion portion 71. The conical plate portion 722a is inclined relative to the axial direction of the insertion portion 71. The conical plate portion 722a is bent relative to the first plate portion 721. The conical plate portion 722a and the first plate portion 721 form a spring structure that is elastically deformable in the axial direction of the insertion portion 71. The second plate portion 722 is bent relative to the first plate portion 721, so that the second plate portion 722 and the first plate portion 721 form a spring structure.

The circular plate portion 722b is continuous with the conical plate portion 722a. The circular plate portion 722b has a flat plate shape. The circular plate portion 722b extends outward in the radial direction of the insertion portion 71 from an outer edge of the conical plate portion 722a. The circular plate portion 722b extends in the same direction as the direction in which the first plate portion 721 extends. The circular plate portion 722b is bent relative to the conical plate portion 722a. The circular plate portion 722b and the conical plate portion 722a form a spring structure that is elastically deformable in the axial direction of the insertion portion 71. The second plate portion 722 alone has a spring structure that is elastically deformable in the axial direction of the insertion portion 71.

As illustrated in FIG. 4, in the contact portion 72 of the first potential equalization member 701, a part of the first plate portion 721 is in surface contact with the first surface 82f of the second housing forming member 82. In the contact portion 72 of the first potential equalization member 701, the circular plate portion 722b of the second plate portion 722 is in surface contact with the axial end surface 81n of the first housing forming member 81. The circular plate portion 722b of the second plate portion 722 is in surface contact with the axial end surface 81n in the radial direction of the insertion portion 71, at a position being spaced from the tapered surface 81s of the first insertion hole 81p.

As illustrated in FIG. 5, in the contact portion 72 of the second potential equalization member 702, the first plate portion 721 is in surface contact with the first surface 82f of the second housing forming member 82. In the contact portion 72 of the second potential equalization member 702, the circular plate portion 722b of the second plate portion 722 is in surface contact with the open end surface 81g of the first housing forming member 81. The circular plate portion 722b of the second plate portion 722 is in surface contact with the open end surface 81g in the radial direction of the insertion portion 71, at a position being spaced from the tapered surface 81u of the second insertion hole 81q.

As illustrated in FIG. 4 and FIG. 5, the spring structure formed by the first plate portion 721 and the second plate portion 722 and the spring structure of the second plate portion 722 are compressed in the axial direction of the insertion portion 71 by the fastening force of the bolt B1 illustrated in FIG. 1. Thus, the first plate portion 721 is pressed against the first surface 82f of the second housing forming member 82 by an elastic force of the contact portion 72. The first plate portion 721 is in contact with one of the mating surfaces of the adjacent housing forming members, in which the insertion hole is not formed.

The second plate portion 722 is pressed against the open end surface 81g and the axial end surface 81n of the first housing forming member 81 by the elastic force of the contact portion 72. The second plate portion 722 is in contact with the other of the mating surfaces of the adjacent housing forming members, in which the insertion hole is formed.

The contact portion 72 of each of the potential equalization members 70 has a spring structure generating the elastic force in a direction in which the mating surfaces of the adjacent housing forming members are spaced from each other. The contact portion 72 of the present embodiment is in surface contact with both the mating surfaces of the adjacent housing forming members. A contact area between the first housing forming member 81 and each of the potential equalization members 70 and a contact area between the second housing forming member 82 and each of the potential equalization members 70 are set such that potential equalization between the first housing forming member 81 and the second housing forming member 82 is certainly performed.

### Operations of Embodiment

Operations of the present embodiment will be described.

When the electric compressor 10 is mounted on the vehicle, each of the mounting legs 81c of the first housing forming member 81 and each of the mounting legs 83c of the third housing forming member 83 are attached to the vehicle body with bolts, so that the electric compressor 10 is mounted on the vehicle body. The first housing forming member 81 and the third housing forming member 83 are electrically connected to the vehicle body. That is, the first housing forming member 81 and the third housing forming member 83 are grounded via the vehicle body. The first housing forming member 81, the fourth housing forming member 84, and the fifth housing forming member 85 are electrically connected to each other with a plurality of bolts (not illustrated), as described above. Thus, the fourth housing forming member 84 and the fifth housing forming member 85 are also grounded.

In a case where the electric compressor 10 does not include the potential equalization members 70, the second housing forming member 82 is insulated from the first housing forming member 81 and the third housing forming member 83 by the first seal member 61 and the second seal member 62. While the first housing forming member 81 and the third housing forming member 83 are electrically connected to each other with the bolt B1, the second housing forming member 82 is not in contact with the bolt B1. As a result, among the first housing forming member 81, the second housing forming member 82, the third housing forming member 83, the fourth housing forming member 84, and the fifth housing forming member 85, only the second housing forming member 82 is not grounded. Thus, the potential of the second housing forming member 82 may become higher than the potentials of the first housing forming member 81, the third housing forming member 83, the fourth housing forming member 84, and the fifth housing forming member 85. In this respect, in the present embodiment, the first housing forming member 81 and the second housing forming member 82 are electrically connected to each other by the potential equalization members 70. This equalizes the potentials of the first housing forming member 81 and the second housing forming member 82.

In the electric compressor 10 of the present embodiment, a case where the first housing forming member 81 and the second housing forming member 82 are assembled with each other is assumed. In this case, the insertion portion 71 of the first potential equalization member 701 is inserted into the first insertion hole 81p, and the insertion portion 71 of the second potential equalization member 702 is inserted into the second insertion hole 81q. Then, when the first housing forming member 81 and the second housing forming member 82 are assembled with each other, the contact portion 72 is naturally sandwiched between the mating surfaces facing each other, thereby coming into contact with both the mating surfaces. That is, the first housing forming member 81 and the second housing forming member 82 are assembled while potential equalization between the first housing forming member 81 and the second housing forming member 82 is performed, without checking positions of the potential equalization members 70 at a time of assembling the first housing forming member 81 and the second housing forming member 82 with each other.

### Effects of Embodiment

Effects of the present embodiment will be described.

(1-1) When the first housing forming member 81 and the second housing forming member 82 are assembled with each other, the insertion portion 71 of the first potential equalization member 701 is inserted into the first insertion hole 81p, and the insertion portion 71 of the second potential equalization member 702 is inserted into the second insertion hole 81q. Then, when the first housing forming member 81 and the second housing forming member 82 are assembled with each other, the contact portion 72 is naturally sandwiched between the mating surfaces facing each other, thereby coming into contact with both the mating surfaces. That is, the first housing forming member 81 and the second housing forming member 82 are assembled while potential equalization between the first housing forming member 81 and the second housing forming member 82 is performed, without checking positions of the potential equalization members 70 at a time of assembling the first housing forming member 81 and the second housing forming member 82 with each other. This facilitates potential equalization between and assembling of the first housing forming member 81 and the second housing forming member 82.

(1-2) A case where the contact portion 72 of each of the potential equalization members 70 has a flat plate shape is assumed. In this case, a thickness of the contact portion 72 needs to be managed so that an interference of the first seal member 61 is secured. Thus, when the first housing forming member 81 and the second housing forming member 82 are assembled with each other, securing the interference of the first seal member 61 requires time and effort.

In the present embodiment, the contact portion 72 has the spring structure. Thus, the mating surfaces facing each other of the first housing forming member 81 and the second housing forming member 82 provide a room for pressing and causing the contact portion 72 to be deformed such that the interference of the first seal member 61 is secured, without adjusting the thickness of the contact portion 72. As a result, when the first housing forming member 81 and the second housing forming member 82 are assembled with each other, the interference of the first seal member 61 is easily secured.

The contact portion 72 is crimped on the mating surfaces of the first housing forming member 81 and the second housing forming member 82 by the elastic force of the pressed contact portion 72. This secures a state where the contact portion 72 is in contact with the mating surfaces of the first housing forming member 81 and the second housing forming member 82 by the elastic force of the contact portion 72, without precisely controlling a state where the contact portion 72 is in contact with the mating surfaces of the first housing forming member 81 and the second housing forming member 82, at a time of assembling the first housing forming member 81 and the second housing forming member 82 with each other. Thus, a state where potentials of the first housing forming member 81 and the second housing forming member 82 are equalized are easily maintained. This easily secures the interference of the first seal member 61 at a time of assembling the first housing forming member 81 and the second housing forming member 82 with each other, and easily maintains a state where the potentials of the first housing forming member 81 and the second housing forming member 82 are equalized.

(1-3) The outer circumferential surface 711a of the insertion portion 71 is in contact with the inner circumferential surface 81r of the first insertion hole 81p and the inner circumferential surface 81t of the second insertion hole 81q. This easily secures the contact area between the first housing forming member 81 and one of the potential equalization members 70, and the contact area between the second housing forming member 82 and the other of the potential equalization members 70. Thus, the potential equalization between the first housing forming member 81 and the second housing forming member 82 are more certainly performed.

The outer circumferential surface 711a of the insertion portion 71 is pressed against the inner circumferential surface 81r of the first insertion hole 81p and the inner circumferential surface 81t of the second insertion hole 81q by the elastic force of the insertion portion 71. This prevents the potential equalization members 70 from falling off from the first housing forming member 81 when the first housing forming member 81 and the second housing forming member 82 are assembled with each other.

(1-4) When the insertion portion 71 of each of the potential equalization members 70 is inserted into the first insertion hole 81p and the second insertion hole 81q, the second tubular portion 71b is guided along the inner circumferential surface 81r of the first insertion hole 81p and the inner circumferential surface 81t of the second insertion hole 81q. Thus, the insertion portion 71 of each of the potential equalization members 70 is smoothly inserted into the first insertion hole 81p and the second insertion hole 81q. This easily performs assembling of the potential equalization members 70 to the first housing forming member 81.

(1-5) The contact portion 72 is in surface contact with the mating surfaces facing each other of the first housing forming member 81 and the second housing forming member 82 to easily secure the contact area between the first housing forming member 81 and one of the potential equalization members 70, and the contact area between the second housing forming member 82 and the other of the potential equalization members 70. This certainly performs the potential equalization between the first housing forming member 81 and the second housing forming member 82.

(1-6) A case where the first potential equalization member 701 is disposed at the open end surface 81g whose dimension increases is assumed. In this case, when the dimension of the open end surface 81g increases, the peripheral wall 81b of the first housing forming member 81 becomes thick. Then, the electric compressor 10 enlarges due to enlargement of the first housing forming member 81.

In this respect, the extended wall portion 81k extends from the arc surface 81m of the groove 81j toward the inside of the peripheral wall 81b, and does not block a flow of the refrigerant flowing from the groove 81j toward the communication hole 82j. The first potential equalization member 701 is provided at the extended wall portion 81k. As a result, the first potential equalization member 701 can be arranged without changing the thickness of the peripheral wall 81b of the first housing forming member 81, and does not hinder the refrigerant being drawn by the compression part 30. Thus, the first potential equalization member 701 is appropriately provided in the electric compressor 10 without enlargement of the electric compressor 10 and without hinderance of the refrigerant compression by the electric compressor 10.

(1-7) The first potential equalization member 701 and the second potential equalization member 702 are provided at positions symmetrical to each other in the radial direction of the rotary shaft 20. Thus, the elastic force of the contact portion 72 of each of the first potential equalization member 701 and the second potential equalization member 702 is applied to positions symmetrical to each other, at a gap between the mating surfaces of the first housing forming member 81 and the second housing forming member 82. Thus, a portion in which the interference of the first seal member 61 is locally small is not formed. This suitably maintains a sealing property between the first housing forming member 81 and the second housing forming member 82.

(1-8) A case where a third insertion hole facing the first insertion hole 81p is formed in the flange wall 82c of the second housing forming member 82 and a potential equalization member having a tubular shape is inserted into the first insertion hole 81p and the third insertion hole, is assumed, for example. In this case, positions of the first insertion hole 81p and the third insertion hole may shift due to manufacturing errors. Then, when the potential equalization member is inserted into the first insertion hole 81p and the third insertion hole to assemble the first housing forming member 81 and the second housing forming member 82 with each other, an axis of the first housing forming member 81 may not coincide with an axis of the second housing forming member 82. That is, alignment of the housing 11 cannot be performed.

In this respect, in the present embodiment, the contact portion 72 extends in a gap between the mating surfaces of the first housing forming member 81 and the second housing forming member 82. This implements the alignment of the housing 11 without hinderance of the potential equalization between the first housing forming member 81 and the second housing forming member 82 by the potential equalization members 70. Since the potential equalization members 70 do not affect the alignment of the housing 11, both the alignment of the housing 11 and the potential equalization between the first housing forming member 81 and the second housing forming member 82 are performed.

(1-9) In the first potential equalization member 701, the circular plate portion 722b of the second plate portion 722 is in surface contact with the axial end surface 81n in the radial direction of the insertion portion 71 at a position being spaced from the tapered surface 81s of the first insertion hole 81p. In the second potential equalization member 702, the circular plate portion 722b of the second plate portion 722 is in surface contact with the open end surface 81g in the radial direction of the insertion portion 71 at a position spaced from the tapered surface 81u of the second insertion hole 81q. That is, the contact portion 72 is in contact with the mating surface of the first housing forming member 81 so as not to be pushed onto the tapered surfaces 81s and 81u. Thus, the contact area between the contact portion 72 and the first housing forming member 81 is not reduced.

### Second Embodiment

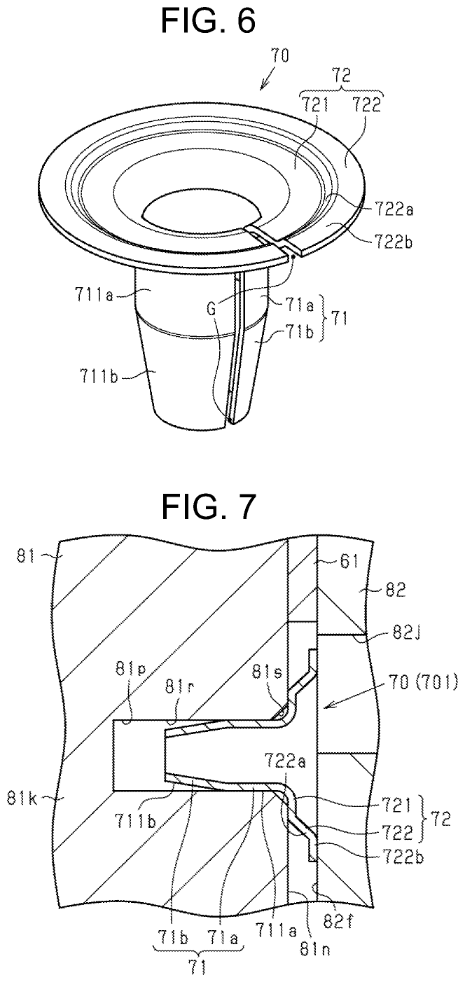

Hereinafter, a second embodiment of the electric compressor will be described with reference to FIG. 6 to FIG. 8. A configuration of the contact portion 72 of the second embodiment is mainly different from that of the first embodiment, and such a difference will be described in detail. The description of the same configuration as the first embodiment will be given with the same reference signs, and detailed description will be omitted.

Contact Portion of Potential Equalization Member

As illustrated in FIG. 6, in the contact portion 72 of each of the potential equalization members 70, the conical plate portion 722a of the second plate portion 722 extends from the outer edge of the first plate portion 721 toward the radially outward side of the insertion portion 71 as being spaced from the first end of the insertion portion 71 in the axial direction of the insertion portion 71. The conical plate portion 722a is inclined relative to the axial direction of the insertion portion 71. The conical plate portion 722a is bent relative to the first plate portion 721. The conical plate portion 722a and the first plate portion 721 form a spring structure that is elastically deformable in the axial direction of the insertion portion 71. The second plate portion 722 is bent relative to the first plate portion 721, so that the second plate portion 722 and the first plate portion 721 form a spring structure.

As illustrated in FIG. 7, in the contact portion 72 of the first potential equalization member 701, the first plate portion 721 is in surface contact with the axial end surface 81n of the first housing forming member 81. In the contact portion 72 of the first potential equalization member 701, a part of the circular plate portion 722b of the second plate portion 722 is in surface contact with the first surface 82f of the second housing forming member 82.

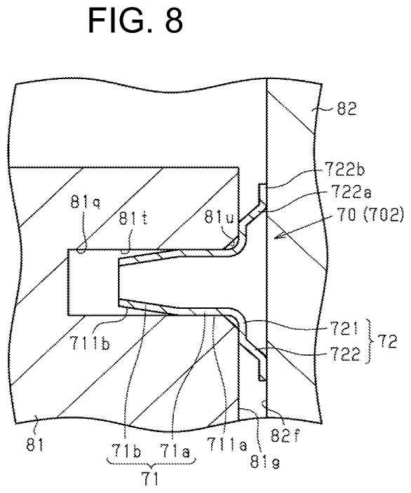

As illustrated in FIG. 8, in the contact portion 72 of the second potential equalization member 702, the first plate portion 721 is in surface contact with the open end surface 81g of the first housing forming member 81. In the contact portion 72 of the second potential equalization member 702, the circular plate portion 722b of the second plate portion 722 is in surface contact with the first surface 82f of the second housing forming member 82.

As illustrated in FIG. 7 and FIG. 8, the spring structure formed of the first plate portion 721 and the second plate portion 722, and the spring structure of the second plate portion 722 are compressed in the axial direction of the insertion portion 71 by the fastening force of the bolt B1 illustrated in FIG. 1. Thus, the first plate portion 721 is pressed against the axial end surface 81n and the open end surface 81g of the first housing forming member 81 by the elastic force of the contact portion 72.

The first plate portion 721 is in contact with the mating surface of one of the adjacent housing forming members, in which an insertion hole is formed. The second plate portion 722 is pressed against the first surface 82f of the second housing forming member 82 by the elastic force of the contact portion 72. The second plate portion 722 is in contact with the mating surface of the other of the adjacent housing forming members, in which the insertion hole is not formed.

The contact portion 72 of each of the potential equalization members 70 has a spring structure generating the elastic force in a direction in which the mating surfaces facing each other of the adjacent housing forming members are spaced from each other. The contact portion 72 of the present embodiment is in contact with both the facing mating surfaces of the adjacent housing forming members.

### Operations and Effects of Embodiment

The second embodiment obtains the same operations and the same effects as those in the descriptions (1-1) to (1-8) described above.

### MODIFIED EMBODIMENTS

The above-described embodiments may be modified and implemented as follows. The embodiments and the following modified embodiments may be implemented in combination with each other to the extent that there is no technical contradiction.

The contact portion 72 of the potential equalization members 70 may have a configuration in which a waveform shape is periodically repeated in the radial direction of the insertion portion 71. Even in this case, the contact portion 72 is pressed and deformed by the fastening force of the bolt B1 at a position between the mating surfaces facing each other of the first housing forming member 81 and the second housing forming member 82. At this time, a width of the waveform of the contact portion 72 extends in the radial direction of the insertion portion 71. The contact portion 72 may be a spring structure that is elastically deformable in the radial direction of the insertion portion 71. The contact portion 72 of each of the potential equalization members 70 need not be in surface contact with the mating surfaces facing each other of the first housing forming member 81 and the second housing forming member 82. When the present modified embodiment is adopted, contact areas between the contact portion 72 and the mating surfaces facing each other of the first housing forming member 81 and the second housing forming member 82 are set such that the potentials of the first housing forming member 81 and the second housing forming member 82 are equalized.

The second plate portion 722 alone need not have the spring structure. The second plate portion 722 of the contact portion 72 need not have the circular plate portion 722b, and may be formed of the conical plate portion 722a. The contact portion 72 may be formed into a flat plate. Opposite surfaces of the contact portion 72 in the thickness direction thereof are simply required to be contact with the mating surfaces facing each other of the first housing forming member 81 and the second housing forming member 82.

The contact portion 72 need not have a circular plate shape. The contact portion 72 is simply required to have a plate shape extending in a gap between the mating surfaces of the first housing forming member 81 and the second housing forming member 82 facing each other. A shape of the contact portion 72 is appropriately changed, so that the contact areas between the contact portion 72 and the mating surfaces facing each other of the first housing forming member 81 and the second housing forming member 82 are set so as to equalize the potentials of the first housing forming member 81 and the second housing forming member 82.

The insertion portion 71 of each of the potential equalization members 70 need not have the second tubular portion 71b, and may be formed only of the first tubular portion 71a.

An outer diameter of the outer circumferential surface 711a of the insertion portion 71 may be equal to or smaller than an inner diameter of the inner circumferential surface 81r of the first insertion hole 81p and an inner diameter of the inner circumferential surface 81t of the second insertion hole 81q, before the insertion portion 71 is inserted into the first insertion hole 81p and the second insertion hole 81q. In this case, the shape of the contact portion 72 is appropriately changed, so that the contact areas between the contact portion 72 and the mating surfaces of the first housing forming member 81 and the second housing forming member 82 facing each other are set so as to equalize the potentials of the first housing forming member 81 and the second housing forming member 82.

The gap G may be omitted from each of the potential equalization members 70.

Each of the potential equalization members 70 need not be formed of a single thin plate. For example, each of the potential equalization members 70 may be formed of the insertion portion 71 having a solid cylindrical shape and the contact portion 72. In this case, only the contact portion 72 is simply required to be formed by a thin plate. The gap G formed in the contact portion 72 may be omitted. The insertion portion 71 may be fitted into the first insertion hole 81p and the second insertion hole 81q, or may be clearance-fitted.

Each of the inner circumferential surface 81r of the first insertion hole 81p and the inner circumferential surface 81t of the second insertion hole 81q need not be a cylindrical surface, and may be a square cylindrical surface, for example. A shape of each of the inner circumferential surface 81r of the first insertion hole 81p and the inner circumferential surface 81t of the second insertion hole 81q may be appropriately changed. In this case, when the contact areas between the insertion portion 71 and the inner circumferential surfaces 81r, 81t are required to enlarge, the shape of the insertion portion 71 is preferably set to conform with the shapes of the inner circumferential surfaces 81r, 81t.

The first insertion hole 81p and the second insertion hole 81q need not be formed in the mating surface of the first housing forming member 81, and may be formed in the mating surface of the second housing forming member 82. In this case, the first surface 82f of the second housing forming member 82 corresponds to the mating surface in which the insertion hole is formed, and the open end surface 81g and the axial end surface 81n of the first housing forming member 81 correspond to the mating surface in which the insertion hole is not formed.

The first insertion hole 81p and the second insertion hole 81q need not be provided at positions symmetrical to each other in the radial direction of the rotary shaft 20. That is, the first potential equalization member 701 and the second potential equalization member 702 need not be provided at positions symmetrical to each other in the radial direction of the rotary shaft 20.

One of the first insertion hole 81p and the second insertion hole 81q may be omitted. That is, one of the first potential equalization member 701 and the second potential equalization member 702 may be omitted. When the first insertion hole 81p is omitted, the extended wall portion 81k is preferably omitted. However, when one of the first potential equalization member 701 and the second potential equalization member 702 is omitted, the contact areas between the other of the first potential equalization member 701 and the second potential equalization member 702 and the first housing forming member 81 and the second housing forming member 82 are secured such that the potentials of the first housing forming member 81 and the second housing forming member 82 are equalized.

The number of the potential equalization members 70 may be three or more. In this case, in addition to the first insertion hole 81p and the second insertion hole 81q, an insertion hole into which the insertion portion 71 of each of the potential equalization members 70 is inserted is newly formed.

The potential equalization members 70 need not be provided at a gap between the mating surfaces facing each other of the first housing forming member 81 and the second housing forming member 82. For example, the potential equalization members 70 may be provided at a gap between the mating surfaces of the second housing forming member 82 and the third housing forming member 83. The second housing forming member 82 and the third housing forming member 83 correspond to the housing forming members adjacent to each other. The open end surface 83e of the third housing forming member 83 corresponds to the mating surface of the third housing forming member 83. The second surface 82g of the second housing forming member 82 corresponds to the mating surface of the second housing forming member 82. The second seal member 62 is a seal member that has an insulation property and is provided between the second housing forming member 82 and the third housing forming member 83. An insertion hole is formed in the mating surface of one of the second housing forming member 82 and the third housing forming member 83 at a position in which the second seal member 62 is not provided. The insertion portion 71 of each of the potential equalization members 70 is inserted into the insertion hole. The contact portion 72 of each of the potential equalization members 70 extends in a gap between the open end surface 83e and the second surface 82g, and is in contact with both the open end surface 83e and the second surface 82g. As with the present modified embodiment, each of the potential equalization members 70 may be disposed at a position between the first housing forming member 81 and the fourth housing forming member 84. Each of the potential equalization members 70 may be disposed at a position between the fourth housing forming member 84 and the fifth housing forming member 85.

The housing 11 need not be formed by all the housing forming members arranged in the axial direction of the rotary shaft 20. For example, the electric compressor 10 may be configured such that the fourth housing forming member 84 and the fifth housing forming member 85 are adjacent to the first housing forming member 81 in the radial direction of the rotary shaft 20.

A type of the compression part 30 is not limited to a scroll type, and may be a piston type or a vane type, for example.

The usage of the electric compressor 10 is not limited to the vehicle air conditioner. The electric compressor 10 is simply required to compress a refrigerant, and an application example of the electric compressor 10 may be appropriately changed.

The electric compressor 10 may be mounted on a fuel cell vehicle, and the compression part 30 may compress air serving as fluid supplied to a fuel cell.

### SUPPLEMENT

Technical ideas obtained from the above-described embodiments and modified embodiments will be described.
(1) An electric compressor including: a compression part that compresses fluid; an electric motor that drives the compression part; an inverter that drives the electric motor; a housing that accommodates the compression part, the electric motor, and the inverter and has a plurality of housing forming members made of metal; a seal member that has an insulating property and is provided between the housing forming members adjacent to each other; and a potential equalization member that is made of metal and is in contact with both the adjacent housing forming members to equalize potentials of the adjacent housing forming members. The adjacent housing forming members includes mating surfaces, respectively, sandwiching the seal member. An insertion hole is formed in one of the housing forming members, at a position in which the seal member is not formed. Each of the potential equalization members includes an insertion portion inserted into the insertion hole, and a contact portion that is a plate portion extending in a gap between the mating surfaces facing each other and in contact with both the mating surfaces.
(2) In the electric compressor according to (1), the contact portion has a spring structure that generates an elastic force in a direction in which the mating surfaces are spaced from each other.
(3) In the electric compressor according to (2), the contact portion is continuous with the insertion portion, and includes a first plate portion being in contact with one of the mating surfaces in which the insertion hole is not formed, and a second plate portion being in contact with the other of the mating surfaces in which the insertion hole is formed. The second plate portion is bent relative to the first plate portion, so that the first plate portion and the second plate portion form the spring structure.
(4) In the electric compressor according to (2), the contact portion is continuous with the insertion portion, and includes a first plate portion being in contact with one of the mating surfaces in which the insertion hole is formed, and a second plate portion being in contact with the other of the mating surfaces in which the insertion hole is not formed. The second plate is bent relative to the first plate portion, so that the first plate portion and the second plate portion form the spring structure.
(5) In the electric compressor according to any one of (1) to (4), the insertion portion is formed by curving a thin plate into a cylindrical shape. An outer circumferential surface of the insertion portion is pressed against and in contact with an inner circumferential surface of the insertion hole by an elastic force.
(6) In the electric compressor according to (5), the insertion portion includes a first tubular portion having the outer circumferential surface, and a second tubular portion formed integrally with the first tubular portion. An outer diameter of the second tubular portion is gradually reduced as being away from the contact portion in an axial direction of the insertion portion.
(7) In the electric compressor according to any one of (1) to (6), the contact portion is in contact with both the mating surfaces facing each other.

What is claimed is:

1. An electric compressor comprising:
a compression part that compresses fluid;
an electric motor that drives the compression part;
an inverter that drives the electric motor;
a housing that accommodates the compression part, the electric motor, and the inverter, and includes a plurality of housing forming members made of metal;
a seal member that has an insulation property and is provided between the housing forming members adjacent to each other; and
a potential equalization member that is made of metal and is in contact with both the adjacent housing forming members to equalize potentials of the adjacent housing forming members, wherein
the adjacent housing forming members include mating surfaces facing each other, respectively, the mating surfaces sandwiching the seal member,
an insertion hole is formed in one of the mating surfaces of the adjacent housing forming members, at a position in which the seal member is not provided, and
the potential equalization member includes an insertion portion inserted into the insertion hole, and a contact portion that is a plate portion extending in a gap between the mating surfaces and is in contact with both the mating surfaces.

2. The electric compressor according to claim 1, wherein
the contact portion has a spring structure that generates an elastic force in a direction in which the mating surfaces are spaced from each other.

3. The electric compressor according to claim 2, wherein
the contact portion includes
a first plate portion that is continuous with the insertion portion and is in contact with the other of the mating surfaces in which the insertion hole is not formed, and
a second plate portion that is bent relative to the first plate portion such that the second plate portion and the first plate portion form the spring structure, the second plate portion being in contact with the one of the mating surfaces in which the insertion hole is formed.

4. The electric compressor according to claim 2, wherein
the contact portion includes
a first plate portion that is continuous with the insertion portion and is in contact with the one of the mating surfaces in which the insertion hole is formed, and
a second plate portion that is bent relative to the first plate portion such that the second plate portion and the first plate portion form the spring structure, the second plate portion being in contact with the other of the mating surfaces in which the insertion hole is not formed.

5. The electric compressor according to claim 1, wherein
the insertion portion is formed by curving a thin plate into a cylindrical shape, and
an outer circumferential surface of the insertion portion is in contact with and pressed against an inner circumferential surface of the insertion hole by the elastic force.

6. The electric compressor according to claim 5, wherein
the insertion portion includes a first tubular portion having the outer circumferential surface, and a second tubular portion formed integrally with the first tubular portion, and
an outer diameter of the second tubular portion is gradually reduced as the second tubular portion is away from the contact portion in an axial direction of the insertion portion.

7. The electric compressor according to claim 1, wherein
the contact portion is in surface contact with both the mating surfaces facing each other.
